(19) United States
(12) Patent Application Publication
(10) Pub. No.: US 2004/0263543 A1
(43) Pub. Date: Dec. 30, 2004

(54) Production method and production apparatus of probe carrier

(75) Inventor: Ayako Maruyama, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/878,612

(22) Filed: Jun. 29, 2004

(30) Foreign Application Priority Data
Jun. 30, 2003 (JP) 2003-186989

(51) Int. Cl. B41J 29/393

(52) U.S. Cl. 347/2; 347/19

(57) ABSTRACT

There are provided a method and an apparatus for producing a probe array excellent in quality with a high yield. When an image including a plurality of immobilized areas of a probe is drawn by a probe solution which is applied to a carrier from a liquid discharging head, a drawing accuracy is previously evaluated on the basis of a preliminary drawn pattern, the evaluation results thus obtained are fed back when an image as a product is drawn on the carrier, thereby improving its yield.

This application claims priority from Japanese Patent Application No. 2003-186989 filed Jun. 30, 2003, which is hereby incorporated by reference.

### BACKGROUND OF THE INVENTION

1. Field of the Invention

The present invention relates to a probe carrier in which probes capable of being specifically bonded to a target substance are immobilized on predetermined positions on the carrier. Additionally, the present invention relates to a method and an apparatus for producing a probe carrier, in particular, a production method and a production apparatus of a probe carrier in which the probes are immobilized on the carrier in a 2-dimensional array arrangement. More specifically, the present invention relates to a production method and a production apparatus of a probe carrier wherein when the probe carrier is produced, drawing evaluations are made as to whether a solution of the probe is drawn on the respective predetermined positions on the carrier with a satisfactory accuracy or not; the evaluation results are fed back to the production method of a probe carrier; and thereby a probe carrier satisfactory in accuracy is produced and hence the process yield is improved.

2. Related Background Art

As one of the techniques which can determine the base sequence of a nucleic acid, can detect a target nucleic acid in a sample, and can identify various bacteria quickly and accurately, a method has been proposed in which, for example, on the basis of the use of a substance capable of being specifically bonded to a target nucleic acid having a specific base sequence, namely, on the basis of the use of a so-called probe, a probe array substrate is formed by arranging a plurality of kinds of probes on a solid phase in a form of an array, and specific bonding capabilities to the plurality of kinds of probes are simultaneously evaluated. The probe carrier is also referred to as a probe array, and is an article in which a large number of different kinds (for example, kinds of from several thousands to ten thousands or more) of DNA fragments are arranged as spots with a high density and immobilized on a glass substrate, a plastic substrate, a membrane or the like.

In recent years, researches on the detection and determination of target substances in which such probe arrays are utilized have been carried out energetically. For example, U.S. Pat. No. 5,424,186 describes a production method of a probe array based on the DNA successive extension reaction on a solid-phase carrier by use of photolithography; International Publication No. WO 95/35505 describes a production method of a probe array in which DNA is supplied to a membrane with the aid of a capillary; European Patent No. 0703825(B1) describes a production method of a probe array in which a plurality kinds of DNAs are solid phase-synthesized with the aid of piezo jet nozzles; and Japanese Patent Application Laid-Open No. H11-187900 describes a production method of a probe array where liquids containing probes are adhered as droplets on a solid phase with the aid of an inkjet head. In any one of these methods, it is important that the variations of the volumes and shapes of the respective spots are suppressed to be low, the intervals between the respective spots are made to be constant, and substances (dusts and minute spots) other than the intended spots are not found.

Additionally, with an intention to attain a further higher density of probe arrays, important are the control of the volumes and shapes and the arrival positions (arrangement of individual spots on predetermined positions) of the spots, and development of methods for producing probe arrays, excellent in productivity, has been demanded.

According to conventional methods for producing probe arrays, an image involving individual spots is obtained after production of a probe array, and from the image thus obtained, the drawing accuracy (the arrival positions, arrival areas, arrival shapes and drawing qualities) of the spots on the carrier is analyzed, the analysis results thus obtained are compared with certain threshold values, and the quality judgment of the probe array and the quality judgment of the liquid discharging head are conducted. Additionally, in the quality judgment on the liquid discharging head or the liquid discharge nozzles, evaluation is made merely on the nozzles that have actually been used. When the evaluation results are found to be poor, the liquid discharging head is immediately replaced.

### SUMMARY OF THE INVENTION

However, in such a quality judgment as described above, the judgment is carried out after the probe array has been produced, so that the yield of the probe array production is not improved in some cases. Additionally, only the used nozzles are evaluated as evaluation items, but the drawing accuracies of the other large number of liquid discharge nozzles do not come to be evaluated. If the head is replaced immediately when the evaluation result is found to be poor, the liquid discharging head is needed to be replaced on the basis of the fact that the evaluation result of only one liquid discharge nozzle is found to be poor, so that the actual situation is such that the cost for preparing new liquid discharging heads is considerably high.

An object of the present invention is the improvement of the yield in the production of probe arrays. Another object of the present invention is to provide a production method and a production apparatus of a probe array satisfactory in quality and satisfactory in yield.

Accordingly, in the pre-drawing prior to the production of a probe array as a finished product, the drawing accuracy is evaluated, the evaluation results thus obtained is fed back to improve the accuracies of the evaluation items, thereby aiming the improvement of the yield. Additionally, the drawing accuracy of all the usable liquid discharging units is evaluated, the evaluation results thus obtained is fed back, and thus, the selection of the liquid discharging units is made such that the liquid discharging units evaluated as poor are replaced by the liquid discharging units evaluated as satisfactory within one and the same liquid discharging head, so that head replacement period can be elongated and the cost reduction can be actualized.

In other words, the production method of a probe carrier according to the present invention is a production method of a probe carrier having an image which is formed by arranging a plurality of immobilized areas of a probe independent from one another at predetermined positions on a carrier, comprising:

a first drawing step of supporting the carrier by a supporting device, relatively moving a liquid discharging head having a plurality of liquid discharging units in relation to the carrier, discharging a probe solution containing a probe capable of being specifically bonded to a target substance to the predetermined positions on the carrier from predetermined liquid discharging units, and drawing a preliminary image comprising a plurality of the immobilized areas of a probe independent from one another on the carrier;

an evaluation step of evaluating the drawing accuracy of the preliminary image on the carrier;

a step of setting drawing conditions to which the results of the evaluation of the drawing accuracy are fed back; and

a second drawing step of, under the drawing conditions, relatively moving a liquid discharging head having a plurality of liquid discharging units in relation to the carrier supported on the supporting device, discharging the probe solution containing the probe capable of being specifically bonded to the target substance to the predetermined positions on the carrier from the predetermined liquid discharging units, and forming a final image comprising a plurality of the immobilized areas of a probe independent from one another on the carrier to obtain the probe carrier.

As the drawing conditions in the second drawing step, drawing conditions can be adopted in which the drawing accuracy in the second drawing step is higher than the drawing accuracy in the first drawing step.

Additionally, it is preferable to conduct, before the first drawing step, a discharge failure-checking step of previously checking whether discharge from each of the liquid discharging units of the liquid discharging head used in the first drawing step is present or absent, and according to the checking results, if necessary, carrying out adjustment of the liquid discharging head. As the discharge failure-checking step, it is possible to preferably adopt a method of checking by drawing on the carrier the discharge failure-checking pattern for checking discharge failure from all or a predetermined part of the liquid discharging units of the liquid discharging head.

On the other hand, as the first drawing step, it is possible to preferably adopt a step of drawing a test pattern for use in the preliminary drawing for evaluating the drawing accuracy of the liquid discharging head. It is preferable that the test pattern for use in the preliminary drawing is a pattern which can evaluate the drawing accuracy of all the liquid discharging units of the liquid discharging head.

Additionally, it is preferable that the evaluation of the drawing accuracy is carried out by forming an image of the test pattern for use in the preliminary drawing through an optical system, and the evaluation is carried out on the basis of the evaluation of at least one item selected from the group consisting of the arrival position, the arrival shape, the arrival area and the drawing quality of the arrived droplets on the image, wherein the quality judgment in the evaluation of each of the items can be made by comparison with a predetermined threshold value. The discharge failure checking of and the preliminary drawing are carried out on a dummy substrate, and preferably on a substrate for use in product formation.

An apparatus for producing a probe carrier according to the present invention is an apparatus for producing a probe carrier having an image which is formed by arranging a plurality of immobilized areas of a probe independent from one another at predetermined positions on a carrier, comprising:

a supporting device for supporting the carrier;

a liquid discharging head comprising a solution holding unit for holding a probe solution containing a probe capable of being specifically bonded to a target substance, and a plurality of liquid discharging units each comprising a discharging opening for discharging a probe solution supplied from the solution holding unit;

a movement means for relatively moving the liquid discharging head in relation to the carrier supported by the supporting device; and

a control means for drawing on the carrier an image comprising a plurality of the immobilized areas of a probe independent from one another by discharging the probe solution from the predetermined liquid discharging units of the liquid discharging head to predetermined positions on the carrier supported by the supporting device,

wherein the control means further comprises a program for use in the first drawing step of drawing on the carrier the test pattern for use in the preliminary drawing for evaluating the drawing accuracy of the liquid discharging head; and a program for use in the second drawing step of forming the probe carrier by driving the liquid discharging head under a drawing condition that the evaluation results based on the test pattern for use in the preliminary drawing are reflected.

As the drawing condition of the second drawing step in the apparatus, it is possible to adopt drawing condition that the drawing accuracy in the second drawing step is higher than the drawing accuracy in the first drawing step.

Additionally, it is preferable that the control means further comprises a program for drawing, on the carrier supported on the supporting device, the discharge failure checking pattern for checking whether discharge from all or a predetermined part of the liquid discharging units of the liquid discharging head used in the first drawing step. Additionally, it is preferable that the test pattern for use in the preliminary drawing is a pattern capable of evaluating the drawing accuracy of all the liquid discharging units of the liquid discharging head.

On the other hand, as the liquid discharging head, a liquid discharging head comprising a thermal energy generator for discharging the probe solution from the liquid discharging units can be preferably used.

The present invention takes the problems into account, accordingly improves the accuracy of the probe array, and thereby improves the yield of the probe array, and at the same time makes it possible to know the time of replacement of the liquid discharging head by carrying out the quality judgment of the liquid discharging head and the liquid discharging units of the liquid discharging head, so that the present invention makes it possible to avoid the unprofitable discarding of the liquid discharging head and thereby makes it possible to reduce the cost.

According to the present invention, on the basis of the drawing method and the method for producing a probe array, both methods comprising the evaluation method, the yield of the probe array production is improved. Additionally, the selection of the nozzles makes it possible to postpone the time of replacement of the liquid discharging head and thus makes it possible to reduce the cost. Additionally, it becomes possible to know the time at which the liquid discharging head should be replaced.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flow chart illustrating the drawing steps before improvement in the present invention;

FIG. 2 is a flow chart illustrating the drawing steps of the present invention;

FIG. 3A illustrates the arrangement of color nozzles of the head for BJF850, and FIG. 3B illustrates the arrangement of the nozzles for each color of the head for BJF850;

FIG. 4 illustrates a test pattern for checking a discharge failure;

FIG. 5 illustrates a conventional test pattern for checking a discharge failure;

FIG. 6A illustrates a drawing pattern, and FIG. 6B illustrates correspondence between the whole nozzles and a set of nozzles;

FIG. 7 illustrates a test pattern for pre-drawing;

FIG. 8A is a schematic diagram illustrating a real data coordinate representation obtained by use of an image processing software, and FIG. 8B is a schematic diagram illustrating a real data coordinate representation after a coordinate transformation;

FIG. 9 is a diagram illustrating correspondence between the position of the center of gravity and an ideal lattice coordinates;

FIG. 10 is a diagram illustrating the direction of the variation in the evaluation of the arrival position;

FIG. 11 is a diagram illustrating normal dots, minute dots and poor dots;

FIG. 12 is a schematic diagram illustrating the nozzle part of a multi-nozzle head;

FIG. 13 is a diagram illustrating the test pattern for checking the discharge failure of a multi-nozzle head;

FIG. 14 illustrates a pre-drawing pattern or a final drawing pattern; and

FIG. 15 is a schematic diagram illustrating nozzles to be used and replacement nozzles.

### DESCRIPTION OF THE PREFERRED EMBODIMENTS

Preferred embodiments of the present invention will now be described in detail in accordance with the accompanying drawings.

Now, more detailed description will be made below of the present invention. The liquid discharging head to be used in the drawing steps comprises holding units (reservoirs) for holding a probe solution, discharge openings communicated with to the holding units each through liquid paths respectively, and discharge energy generators (for example, thermal energy generators) for generating the energy to be used for discharging the probe solution from the discharge openings. Hereinafter, a region including a part of a liquid path and a discharging opening will be referred to as a nozzle. Usually, a plurality of liquid discharging units, in each of which one reservoir is connected to one nozzle, are arranged in a mutually independent manner, but according to need, a configuration in which one reservoir corresponds to a plurality of nozzles may be formed. The placement of the probe solution in the nozzles can be selected according to the desired configuration of the probe carrier; for example, the placement may include the state in which different probe solutions containing different probes are placed in different nozzles respectively, or the placement may include a state in which one and the same probe solution is placed in a plurality of nozzles.

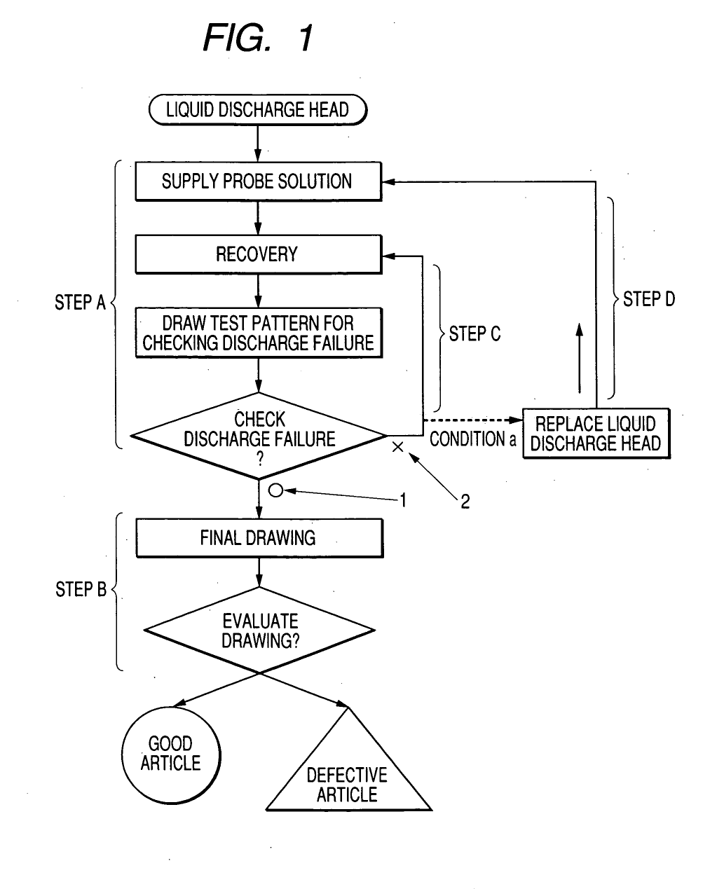

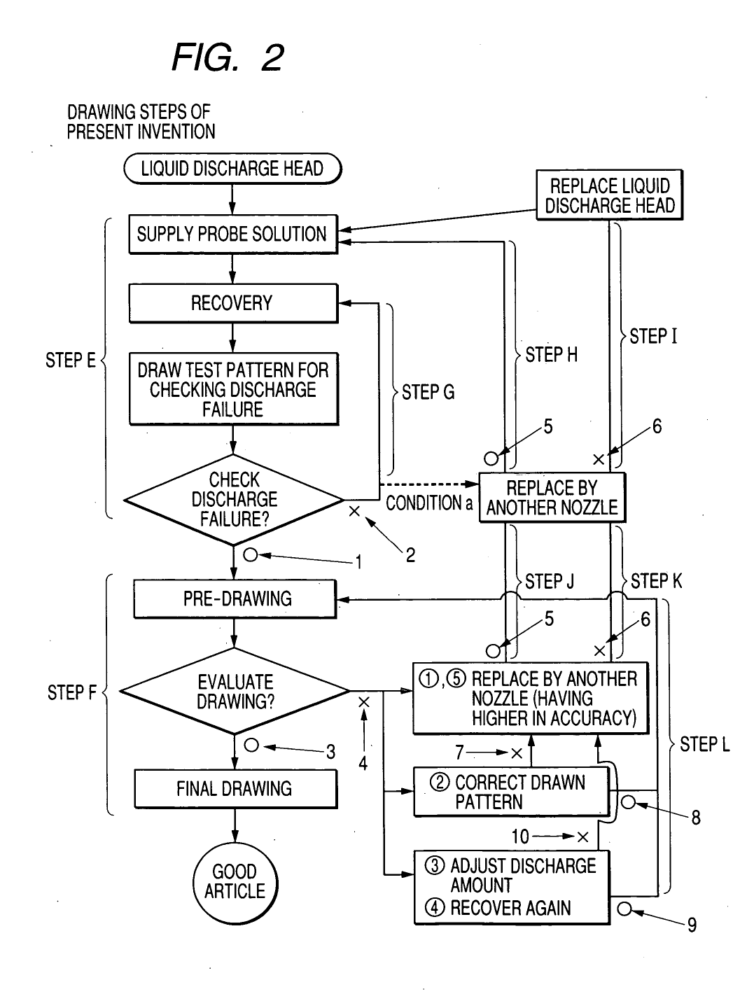

FIG. 1 shows the drawing steps of producing a probe array as a model before improvement in the present invention, and FIG. 2 shows the drawing steps according to the present invention. In the drawing steps shown in FIG. 1, after the probe solution has been supplied to the liquid discharging head, the discharge recovery treatment is applied to the plurality of nozzles of the liquid discharging head, then the test pattern for checking a discharge failure is drawn, and the presence/absence of the discharge failure (nozzles not discharging the solution) is checked by visual checking of the results of the drawn pattern (step A). When no discharge failure is found, final drawing is made and then the evaluation of the image is carried out by acquiring and analyzing the image as a result of the drawing (step B). On the other hand, when the discharge failure is found, the discharge recovery treatment is carried out once again, the test pattern for checking the discharge failure is drawn, and the discharge failure checking is carried out (step C). When the discharge failure persists even after repeating the step C (when the condition a is met (for example, the discharge failure persists even after duplicate recovery is repeated 3 times)), the liquid discharging head is replaced and then the probe solution is supplied, the operations from the discharge recovery treatment to the discharge failure checking are carried out (step D), and the operation is made to proceed to the step B. In this way, quality judgment is carried out on the probe array and the liquid discharging head. In the drawing steps of FIG. 1, the evaluation of the drawing is carried out after the final drawing has been made, so that when the completed probe arrays contain defective articles other than good articles, the proportion of the defective articles as it is comes to be a direct cause for lowering the yield of good articles. In FIG. 1, reference numeral 1 denotes the absence of discharge failure, and 2 denotes the presence of discharge failure.

Now, description will be made below of the drawing steps according to the present invention with reference to FIG. 2. First of all, the step E is similar to the step A. In the step E, when a discharge failure is found to occur, the step G is carried out. When the discharge failure is found to occur even after repeating the step G (when the condition a is met (for example, the discharge failure persists even after duplicate recovery is repeated 3 times)), the replacement with alternative nozzles is made and then the step H is carried out. When the discharge failure is found to occur after the step H, the step G is repeated; when the discharge failure is still found to occur (when the condition a is met), the step H is repeated. When alternative nozzles are eventually exhausted (step I), the head is replaced, and the operation is resumed from the step E. For the purpose of conducting the step H, the liquid discharging head used here has the spare nozzles capable of discharging the same probe solution as the alternative nozzles.

When no discharge failure comes to occur, the preliminary drawing (pre-drawing) is carried out and the drawing evaluation is conducted. The drawing evaluation mainly involves evaluation of at least one item selected from the group consisting of the arrival position, the arrival area, the arrival shape and the drawing quality; when the evaluation results are better than the certain threshold values, the final drawing is conducted (step F). It is preferable that all these evaluation items are evaluated. Additionally, items other than these items may be further added.

When the results of the drawing evaluation are worse than the threshold values, for example, the following five countermeasures are adopted.

(1) When the arrival position, the arrival area and the arrival shape are randomly disturbed, the replacement with other nozzles better in accuracy is made, and the return to the supply of the DNA solution (step J, step H) is conducted. When no alternative nozzles are available, the liquid discharging head is replaced (step K, step I), and the return to the step E is conducted.

(2) When the arrival position is disturbed along a certain direction in a regular manner, the image of the drawing pattern is subjected to correction, and then the pre-drawing is conducted and the drawing evaluation is conducted once again (step L). When still no improvement is found, the replacement with other alternative nozzles is made (steps J, H). When no alternative nozzles come to be available, the liquid discharging head is replaced (steps K, I), and the return to the step E is conducted.

(3) When the arrival area is too small, the double drawing and the discharge amount are adjusted, and the pre-drawing is conducted and the drawing evaluation is carried out once again (step L). When still no improvement is found, replacement with other alternative nozzles is conducted (steps J, H). When no alternative nozzles come to be available, the liquid discharging head is replaced (steps K, I) and the return to the step E is conducted.

(4) When the drawing quality is randomly poor, the recovery operation is made once again, and then the pre-drawing is carried out (step L). When the drawing quality is still poor even after the duplicate recovery is repeated 3 times, the replacement with other alternative nozzles is carried out (steps J, H). When no alternative nozzles come to be available, the liquid discharging head is replaced (steps K, I) and the return to the step E is conducted.

(5) When the drawing quality is poor merely around a certain nozzle, the treatment similar to that in (1) is carried out.

The reference numerals 1 to 10 of FIG. 2 denote the following matters.

1 . . . No discharging failure

2 . . . Discharging failure occurrence

3 . . . Drawing evaluation results falling within the threshold values

4 . . . Drawing evaluation results falling outside the threshold values

5 . . . Replaceable by another nozzle

6 . . . Not replaceable by another nozzle

7 . . . Non-correctable drawing pattern

8 . . . Correctable drawing pattern

9 . . . Adjustable and recoverable discharge amount

10 . . . Non-adjustable and non-recoverable discharge amount

According to the drawing steps in FIG. 2, probe arrays produced after the final drawing can be restricted to good articles.

In the present invention, the probes arranged on a carrier in a form of 2-dimensional array are generally regarded as of the same kind in a broad sense. More specifically, in the present invention, as far as each of the probes can be discharged as a solution from a liquid discharge device, no restriction is imposed on the kind of the probe itself, and the kind of the probe is selected on the basis of the intended purpose of the probe carrier. Additionally, the present invention is applied to a probe which can be immobilized on a carrier after the probe is discharged as a solution onto the carrier and imparted to the carrier. Examples of the probes which meet this requirement include DNA, RNA, cDNA (complementary DNA), PNA, oligonucleotides, polynucleotides, other nucleic acids, oligopeptides, polypeptides, proteins, enzymes, substrates for enzymes, antibodies, epitopes for antibodies, antigens, hormones, hormone receptors, ligands, ligand receptors, oligosaccharides, and polysaccharides. These probes have the structure capable of being bonded to the carrier, and it is preferable that these probes are discharged as the probe solution and imparted to the carrier, and then are made to be bonded to the carrier by taking advantage of the structure capable of being bonded to the carrier. Such structure capable of being bonded to the carrier can be formed by introducing into the probe molecules, for example, the following organic functional groups: amino group, sulfhydryl group, carboxylic group, hydroxy group, acid halide (—COX), halide, aziridine, maleimide, succimide, isothiocyanate, sulfonyl chloride (—SO₂Cl), aldehyde (—CHO), hydrazine, iodoacetamide and the like. In this case, it is necessary to beforehand carry out on the surface of the carrier treatments for introducing the structure for reacting with the various kinds of organic functional groups to form covalent bonds and for introducing organic functional groups.

### EXAMPLES

Specific description will be made below of the preferred examples of the present invention with reference to the accompanying drawings. The examples described below are some of the best examples, but the present invention is not limited by these examples.

### Example 1

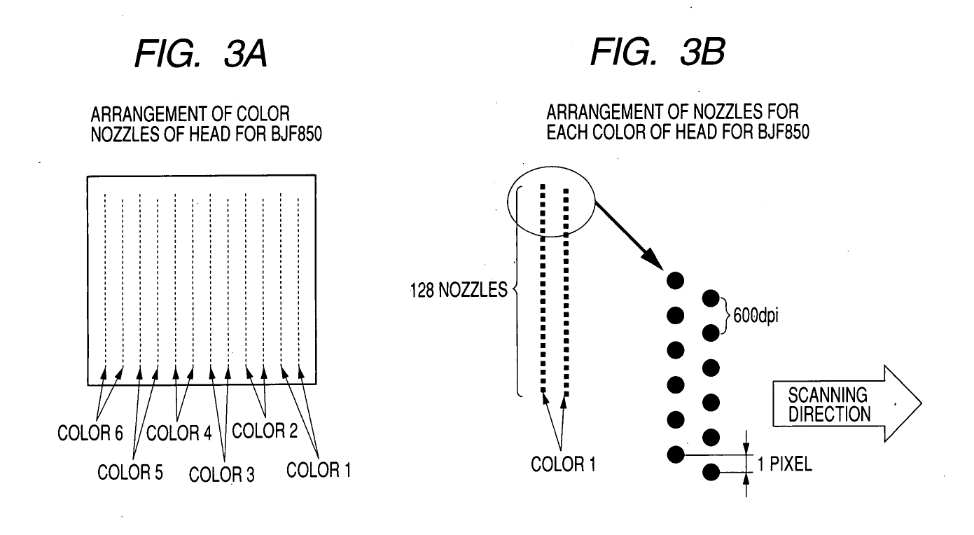

The case of the head for-the printer BJF850 manufactured by Canon Inc. (see FIGS. 3A and 3B)

The head for the printer BJF850 manufactured by Canon Inc., used in the present example, has a nozzle configuration as shown in FIGS. 3A and 3B. FIGS. 3A and 3B are plan views showing the surface on which nozzle openings (discharge openings) of the liquid discharging head are arranged.

FIG. 3A is a diagram showing the discharge openings of the head, and in the case of this head, the maximum of 6 colors can be used. Two columns of nozzles are allotted to each color, and the nozzle columns belonging to each color are arranged as shown in FIG. 3B. The 2 columns in which the nozzles are arranged with even intervals of 600 dpi therebetween are arranged in a staggered manner, and hence a 1,200 dpi recording can be carried out in the scanning direction. This type of arrangement is common to all the colors. A head for the printer BJF850 manufactured by Canon Inc. was used to carry out the following.

Additionally, in the present example, a solution composed of 76.5 mass % of purified water, 7.5 mass % of glycerin, 7.5 mass % of urea, 7.5 mass % of thiodiglycol, and 1.0 mass % of acetylenol (E100) was used.

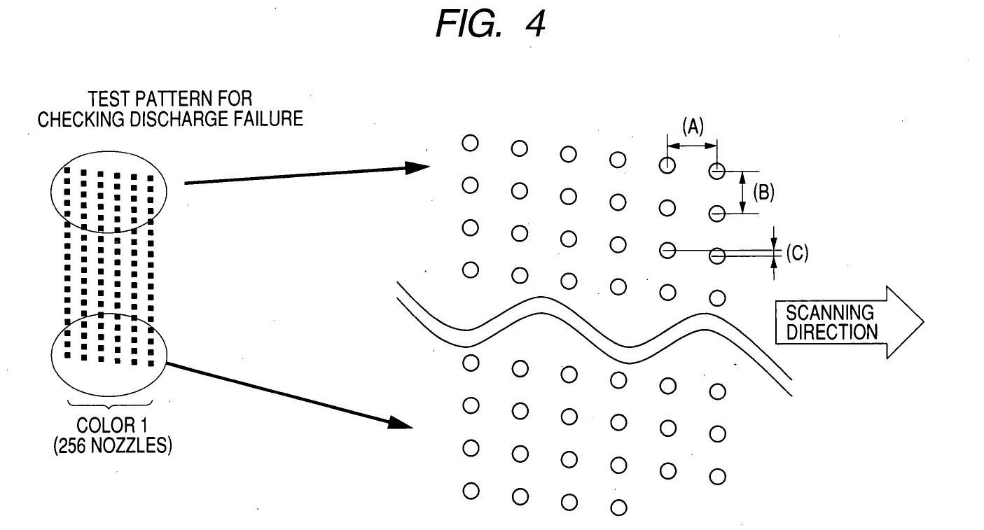

First of all, the pattern for checking the discharge failure in the drawing steps of FIG. 2 was formed as shown in FIG. 4. FIG. 4 shows the positions of the dots formed on the carrier with the aid of the respective nozzles.

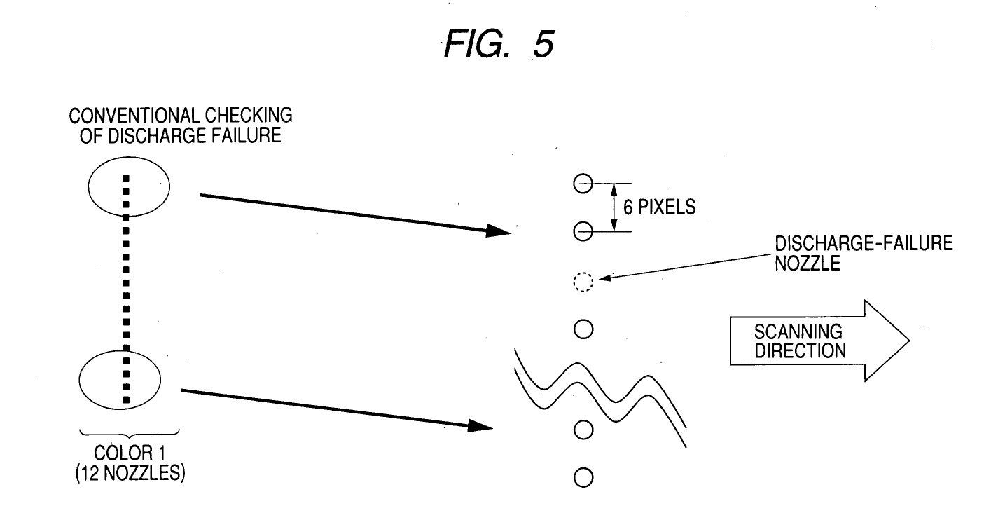

Conventionally, a nozzle to be used is fixed, the discharge failure checking is conducted merely on the fixed nozzle, and when discharge failure cannot be removed, the head is immediately replaced (see FIG. 5). In FIG. 4, all the 256 nozzles for color 1 were arranged on the nozzle opening surface of the liquid discharging head such that the first nozzle in each column was taken as a reference, movement of one nozzle by one nozzle to the right over 6 pixels was made, and the 7-th nozzle was specified to be located just below the first nozzle, and then the test pattern for checking discharge failure was formed as shown in FIG. 4. In FIG. 4, the nozzle columns consist of 6 longitudinal columns and the interval (A) between the dots of adjacent columns is 6 pixels, the interval (B) between the dots within each column is 6 pixels, and the step difference (C) between the adjacent columns is 1 pixel. The drawing was carried out by allotting the above arrangement to each of the 6 colors, and accordingly it became possible that the checking of discharge failure for all the nozzles was carried out at a time through visual or microscope observation.

Additionally, the drawing device holding the carrier was equipped with a microscope, an image processing software (Image-Pro Plug, manufactured by Planetron, Inc.) was used, and thus, all the operations from the image acquisition to the checking of the discharge failure were automated, so that the time required for the checking of the discharge failure of all the nozzles was able to be reduced.

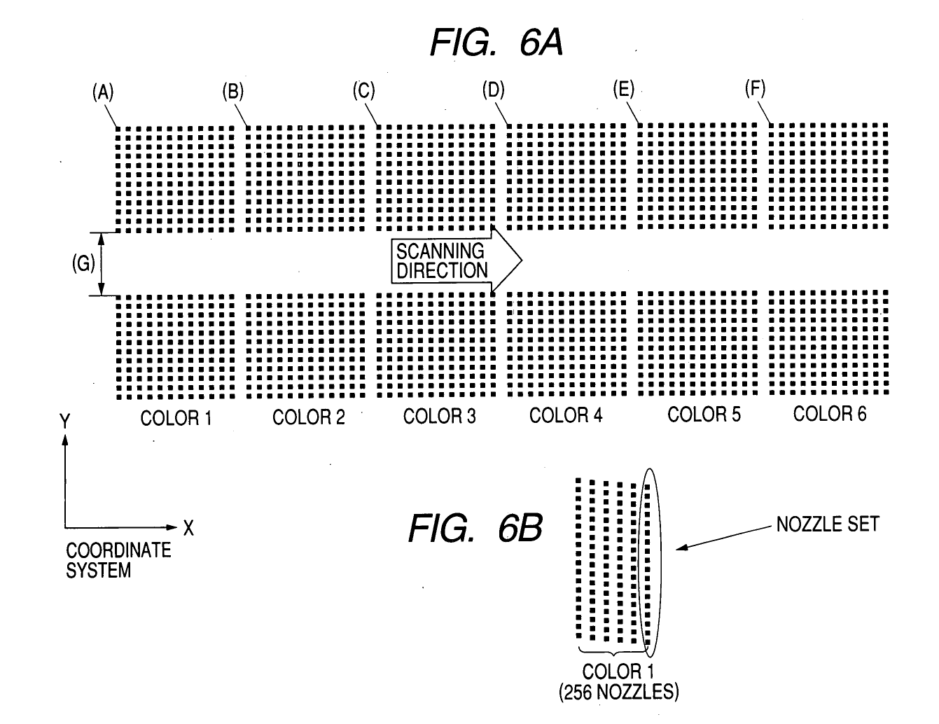

For example, when two matrixes of each colors, each having 12 dots×12 dots with a constant interval of 6 pixels between dots, is intended to be drawn by one scan on a carrier as shown in FIG. 6A, the (6N+1)-th (N=0 to 11, and 22 to 33) nozzle (a nozzle selected from the column of nozzles for forming the leftmost column of dots shown in FIG. 4) is used among the 256 nozzles for each color. Conventionally, when a discharge failure is found for a color, the head is replaced immediately. However, in the present invention, all the nozzles are subjected to checking of discharge failure, and accordingly, even if the discharge failure is found for the color 5 and thus the nozzles for color 5 are a non-usable set of nozzles, usable nozzles of the other 5 sets of nozzles can be used in place of the non-usable nozzles, so that the operation life of the head can be prolonged. The set of nozzles as referred to here means a set of a longitudinal column of nozzles shown in FIG. 4, and 6 sets are allotted to each color (see FIG. 6B).

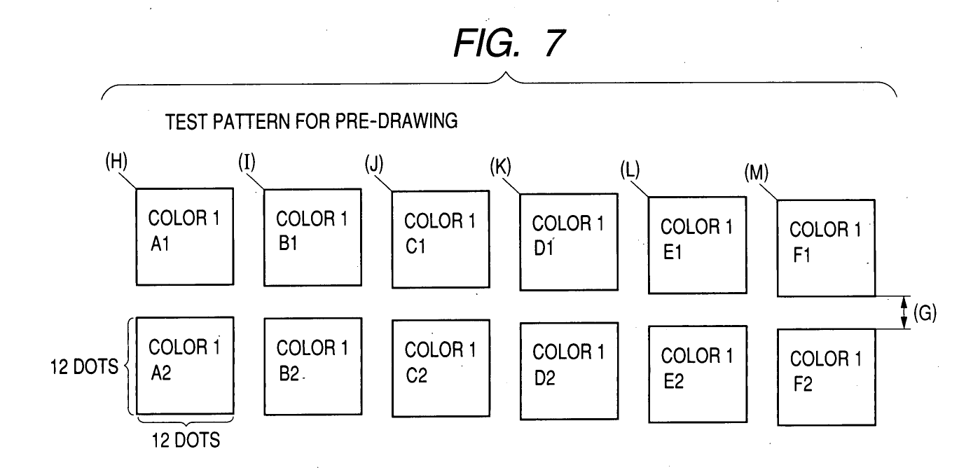

Now, description will be made below of the pre-drawing. The sets of nozzles allotted to each color are allocated as shown in FIG. 7, and thus the drawing is made. Six sets of nozzles are allotted to each color, and each set has 42 dots at the maximum. When drawing having 42 dots with intervals of 6 pixels is made along the main scanning direction with the aid of these sets of nozzles, a matrix of 42 dots×42 dots is drawn. Since six sets of nozzles are allotted to each color, 6 matrixes are drawn, and accordingly, 36 matrixes are drawn for 6 colors. After the operation of drawing, the images of the 36 matrixes is acquired, and the drawing evaluation is conducted. In this way, the drawing accuracy of each set of nozzles for each color can be evaluated, so that drawing can be made by selecting the best column of nozzles. In the drawing evaluation, the arrival position, the arrival area, the arrival shape and the drawing quality are evaluated.

Now, description will be made below of the pre-drawing in the case where such drawing as shown in FIGS. 6A and 6B is intended to be made.

Six sets of nozzles are allotted to each color, and in the combinations of the sets of nozzles to be used in the case of FIGS. 6A and 6B, 6 sets are available for each color. In FIGS. 6A and 6B, the X coordinate axis is parallel with the scanning direction, and the Y coordinate axis is parallel with the sets of nozzles. When drawing is intended to be made by equalizing the Y coordinates of (A), (B), (C), (D), (E) and (F) of the respective colors, there are 6 combinations for all the colors as shown in FIGS. 6A and 6B. More specifically, each of the matrixes (A) to (F) shown in FIGS. 6A and 6B is formed by selecting the same and one column (for example, the rightmost column) as the set of nozzles (longitudinal column) having each color. On the other hand, when the Y coordinates of (A), (B), (C), (D), (E) and (F) of the respective colors are not equalized, the number of the combinations of all the colors amounts to 36. Additionally, the distance (G) between the upper matrix and the lower matrix is 66 pixels, and the distance is equal for all the colors. In the following, the drawing evaluation was carried out for the case where the Y coordinates were equalized. -The test pattern for the pre-drawing used for the drawing evaluation is shown in FIG. 7. FIG. 7 shows a case of one color as a representative example. A to F in FIG. 7 respectively show the dot groups formed by the sets of nozzles (longitudinal columns). Specifically, the dot groups formed by the nozzle groups in the upper ports of the longitudinal columns are shown in the upper row (A1 to F1), while the dot groups formed by the nozzle groups in the bottom ports of the longitudinal columns are shown in the lower row (A2 to F2). Additionally, a total number of 12 matrixes of 12×12 dots with an interval of 6 pixels between the dots are shown. The Y coordinates of (H), (I), (J), (K), (L) and (M) shown in FIG. 7 are shifted from the Y coordinate of (H) downward successively by 1 pixel. As for the X coordinates, it is preferable that the distances (12 pixels or more) between the adjacent matrixes drawn respectively by the combination of 6 sets of nozzles, that is, between two matrixes in each of the pairs, A1 and B1, B1 and C1, C1 and D1, D1 and E1, and E1 and F1, are discriminable from each other (the same is applied to the set of A2, B2, C2, D2, E2 and F2).

After this test pattern for pre-drawing was drawn on a synthetic quartz glass substrate, the drawn images of the respective matrixes were obtained as analyzable data with the aid of a microscope. The drawn image data thus obtained were analyzed with the aid of an image processing software, and the center of gravity XY coordinates, the dot areas and the radius ratios of the respective dots were obtained as numerical values.

In this connection, for example, when by taking advantage of the color configuration, different probe solutions are arranged for different colors, it is possible to arrange 6 kinds of spots in total.

Additionally, the substrate to be used for drawing evaluation need not be a synthetic quartz glass substrate, but it is possible to use a substrate made of an unexpensive material similar to the carrier.

Now, description will be made below of the details of the respective evaluation items and the obtained results.

(1-1) Arrival Position

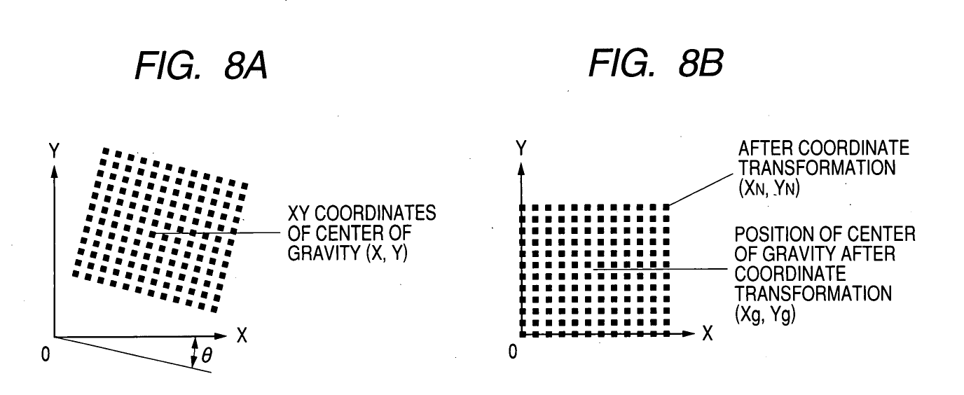

The centers of gravity XY coordinates (X, Y) of the respective matrixes obtained by the image processing software are subjected to the θ correction by use of the least squares method (see FIGS. 8A and 8B). The drawn images obtained with the aid of a microscope are inclined as the case may be as shown in FIG. 8A. Such inclination is corrected as shown in FIG. 8B, and accordingly the coordinate transformation is conducted. The coordinates of the respective dots subjected to the coordinate transformation are represented by (X_{N}, Y_{N}).

After the coordinate transformation, the centers of gravity positions (X_{g}, Y_{g}) of the respective matrixes are obtained, and from these coordinates, the ideal lattice coordinates are made. In the case of the drawing patterns of FIG. 7, the ideal lattice coordinates (Xᵣ, Yᵣ) are represented by the following Equations 1 and 2:

Xᵣ=X_{g}+127.2×r{r=±(N+½) (N=0 to 5)} Equation 1

Yᵣ=Y_{g}+127.2×r{r=±(N+½) (N=0 to 5)} Equation 2

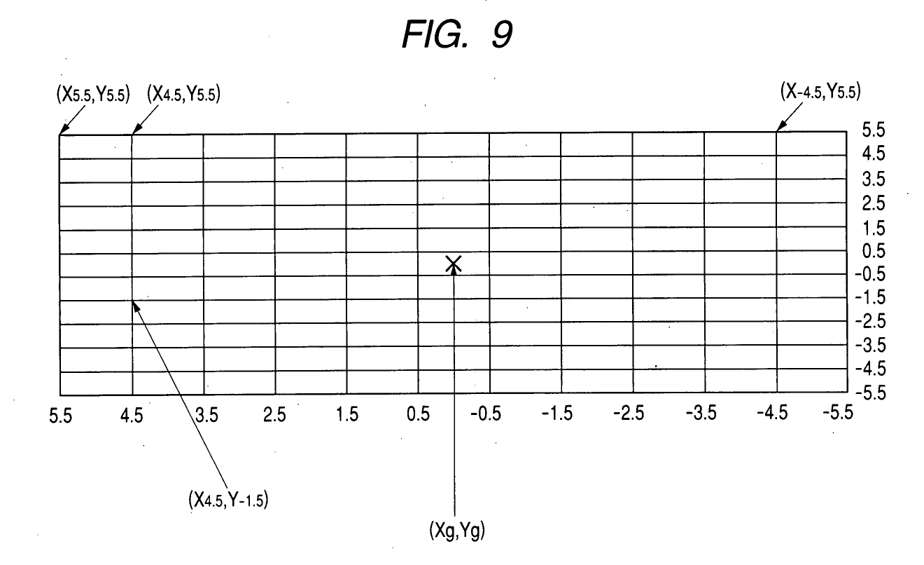

There are 144 ideal lattice coordinates (Xᵣ, Yᵣ) (see FIG. 9). In FIG. 9, the dots are found on the lattice points. From the differences between the ideal lattice coordinates and the real coordinates (X_{N}, Y_{N}) subjected to the coordinate transformation, the deviation magnitudes of the arrival positions at the time of drawing from the ideal lattice coordinates can be obtained.

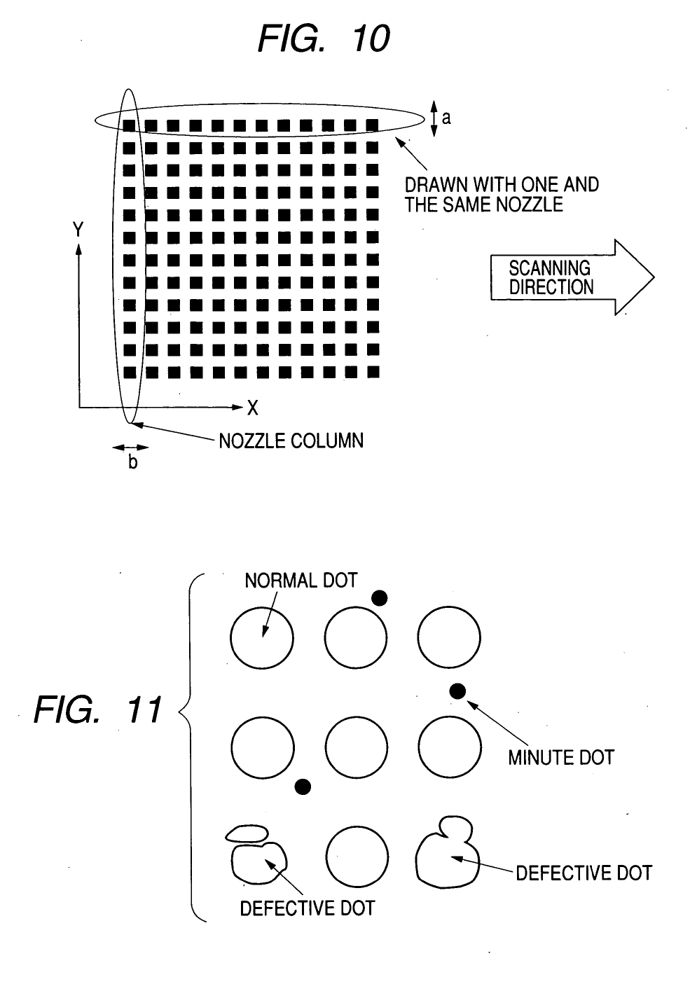

From one matrix, the deviation magnitude of 144 dots can be found, and the respective dots drawn along the scanning direction (the respective rows extending along the X axis direction) are drawn by one and the same nozzle. Therefore, as a method for arrival evaluation, the Y direction variations (“a” in FIG. 10: variation a) along the scanning directions of the nozzles used for drawing (12 nozzles per a matrix) and the X direction variations (“b” in FIG. 10: variation b) along the nozzle column perpendicular to the scanning directions of the nozzles used for drawing were obtained; the 3σ value of the 12 rows and the 3σ value of the 12 columns were averaged, and on the basis of the average value thus obtained, the variation of each matrix was evaluated. Each of the pairs of A1 and A2, B1 and B2, C1 and C2, D1 and D2, E1 and E2, and F1 and F2 are drawn by use of one and the same set of nozzles, and accordingly, when any one of the 2 blocks in a pair is lower in accuracy than the threshold value, the set of nozzles having the lower accuracy was evaluated not to be used. The threshold value concerned is 17.0 μm. The results of the arrival accuracy evaluation are shown in Table 2 by use of the symbols defined in Table 1. (It should be noted that each of the symbols in Table 2 represents the result obtained by averaging the evaluation values for the 2 blocks drawn with a set of nozzles. (See Table 1: Symbols for arrival accuracy, and Table 2: Results of arrival position evaluation.)

TABLE 1
Symbols for arrival accuracy

| | Range of arrival accuracy |
|---|---|
| Symbol | evaluation result |
| ⊚ | 0 μm to 6.9 μm |
| ◯ | 7.0 μm to 11.9 μm |
| Δ | 12.0 μm to 16.9 μm |
| X | 17.0 μm or more |

TABLE 2
Results of arrival position evaluation

| | Color | Color | Color | Color | Color | Color |
|---|---|---|---|---|---|---|
| | 1A | 1B | 1C | 1D | 1E | 1F |
| Variation a | ⊚ | ⊚ | ⊚ | ⊚ | ◯ | ◯ |
| Variation b | ◯ | ◯ | ◯ | ◯ | Δ | Δ |
| | Color | Color | Color | Color | Color | Color |
| | 2A | 2B | 2C | 2D | 2E | 2F |
| Variation a | Δ | ◯ | ◯ | ◯ | ◯ | ◯ |
| Variation b | Δ | Δ | Δ | ◯ | ◯ | Δ |
| | Color | Color | Color | Color | Color | Color |
| | 3A | 3B | 3C | 3D | 3E | 3F |
| Variation a | Δ | ◯ | ◯ | ◯ | ◯ | ◯ |
| Variation b | ◯ | ◯ | Δ | Δ | ◯ | ◯ |
| | Color | Color | Color | Color | Color | Color |
| | 4A | 4B | 4C | 4D | 4E | 4F |
| Variation a | ◯ | ◯ | X | ◯ | ◯ | ◯ |
| Variation b | Δ | ◯ | X | ◯ | Δ | ◯ |
| | Color | Color | Color | Color | Color | Color |
| | 5A | 5B | 5C | 5D | 5E | 5F |
| Variation a | X | ◯ | ◯ | ◯ | ◯ | ◯ |
| Variation b | X | Δ | Δ | Δ | Δ | Δ |
| | Color | Color | Color | Color | Color | Color |
| | 6A | 6B | 6C | 6D | 6E | 6F |
| Variation a | X | X | ◯ | X | ◯ | ◯ |
| Variation b | X | X | Δ | X | Δ | ◯ |

From the results, it has been found that the combinations of the nozzle columns better in accuracy than the threshold value are the nozzle columns of E and F.

(1-2) Arrival Area

The arrival areas (dot areas) obtained from the respective matrixes with the aid of the image processing software were evaluated as follows.

The average value of the arrival areas was obtained for each of the matrixes, and the variation (3σ value) thereof was calculated. Similarly to the case of the arrival position, the average values and the variations in the same set of the nozzles were averaged and used for evaluation. As the evaluation method, the 3σ value of each set of nozzles was divided by the average value of the each set of nozzles, and the value thus obtained was used for evaluation. The threshold value is set at 0.25 or less. The results of the evaluation are shown below (see Table 3: Results of arrival area evaluation).

TABLE 3
Results of arrival area evaluation

| | A | B | C | D | E | F |
|---|---|---|---|---|---|---|
| Color 1 | 0.18 | 0.18 | 0.17 | 0.17 | 0.17 | 0.21 |
| Color 2 | 0.17 | 0.12 | 0.15 | 0.17 | 0.19 | 0.20 |
| Color 3 | 0.15 | 0.14 | 0.18 | 0.21 | 0.16 | 0.20 |
| Color 4 | 0.21 | 0.18 | 0.19 | 0.20 | 0.20 | 0.23 |
| Color 5 | 0.21 | 0.17 | 0.16 | 0.19 | 0.27 | 0.21 |
| Color 6 | 0.18 | 0.18 | 0.17 | 0.17 | 0.18 | 0.18 |
| Average in | 0.18 | 0.16 | 0.17 | 0.19 | 0.20 | 0.21 |
| nozzle columns | | | | | | |

The results shown in Table 3 are lined up in the order of accuracy to obtain the evaluation result of B>C>A>D>E>F.

(1-3) Arrival Shape

By use of the radius ratios obtained from the respective matrixes with the aid of the image processing software, the arrival shapes were evaluated as follows.

The average value of the radius ratios was obtained for each of the matrixes, and the variation (3σ value) thereof was calculated. Similarly to the case of the arrival position, the average values and the variations in the same set of nozzles were averaged and used for evaluation. As the evaluation method, the 3σ value of each set of nozzles was divided by the average value of the each set of nozzles, and the value thus obtained was used for evaluation. The threshold value is set at 0.25 or less (see Table 4. Results of arrival shape evaluation). Additionally, the dots with a radius ratio of 1.4 or more were judged to be abnormal in shape, and the number of such abnormal dots was counted. The threshold value is set at 0.2 for each dot. The results of the evaluation are shown below (see Table 5: Number of dots with a radius ratio of 1.4 or more).

TABLE 4
Results of arrival shape evaluation

| | A | B | C | D | E | F |
|---|---|---|---|---|---|---|
| Color 1 | 0.17 | 0.19 | 0.18 | 0.16 | 0.14 | 0.15 |
| Color 2 | 0.17 | 0.17 | 0.19 | 0.18 | 0.15 | 0.18 |
| Color 3 | 0.17 | 0.18 | 0.18 | 0.17 | 0.14 | 0.16 |
| Color 4 | 0.19 | 0.18 | 0.20 | 0.18 | 0.17 | 0.18 |
| Color 5 | 0.22 | 0.17 | 0.19 | 0.20 | 0.18 | 0.17 |
| Color 6 | 0.22 | 0.20 | 0.25 | 0.20 | 0.19 | 0.18 |
| Average in | 0.19 | 0.18 | 0.20 | 0.18 | 0.16 | 0.17 |
| nozzle columns | | | | | | |

TABLE 5
Number of dots with a radius ratio of 1.4 or more

| | A | B | C | D | E | F |
|---|---|---|---|---|---|---|
| Color 1 | 12 | 1 | 1 | 0 | 4 | 2 |
| Color 2 | 2 | 2 | 3 | 13 | 5 | 2 |
| Color 3 | 2 | 7 | 2 | 2 | 2 | 1 |
| Color 4 | 30 | 14 | 29 | 20 | 32 | 19 |
| Color 5 | 26 | 5 | 5 | 7 | 5 | 11 |
| Color 6 | 23 | 23 | 44 | 18 | 17 | 22 |
| Average in | 15.5 | 8.7 | 14 | 10 | 10.8 | 9.5 |
| nozzle columns | | | | | | |
| Average value | 0.11 | 0.06 | 0.1 | 0.07 | 0.08 | 0.07 |
| for one dot | | | | | | |

The results shown in Table 4 are lined up in the order of accuracy to obtain the evaluation result of E>F>B=D>A>C.

The results shown in Table 5 are lined up in the order of accuracy to obtaine the evaluation result of B>F>D>E>C>A.

(1-4) Drawing Quality

The drawing quality as referred to here means the evaluation based on the observation of the drawn image after drawing, and more specifically, means the evaluation in which the number of the minute dots and the number of the defective dots found in the areas other than the intentionally drawn dots or image, as shown in FIG. 11, are counted and these numbers are used for ranking the matrixes with reference to a threshold value. The threshold values for ranking are shown in Table 6, and the results of evaluation are shown in Table 7. (See Table 6: Threshold values for ranking of drawing quality, and Table 7: Results of drawing quality evaluation.)

TABLE 6
Threshold values for ranking of drawing quality

| Rank | Threshold values for ranking |
|---|---|
| A | The conditions of the ranks D and E are not |
| | satisfied, and the number of the dots each |
| | including minute dots within an area of a |
| | concentric circle having a diameter 3 times as |
| | large as the dot diameter is less than 5% of the |
| | number of the normal dots. |
| B | The conditions of the ranks D and E are not |
| | satisfied, and the number of the dots each |
| | including minute dots within an area of a |
| | concentric circle having a diameter 3 times as |
| | large as the dot diameter is 5% or more and less |
| | than 20% of the number of the normal dots. |
| C | The conditions of the ranks D and E are not |
| | satisfied, and the number of the dots each |
| | including minute dots within an area of a |
| | concentric circle having a diameter 3 times as |
| | large as the dot diameter is 20% or more of the |
| | number of the normal dots. |
| D | The condition of the rank E is not satisfied, |
| | and the number of the minute dots included |
| | within an area of a concentric circle having a |
| | diameter 3 times as large as the dot radius is |
| | 10 or more. When the minute dots are |
| | distributed within the matrixes, both matrixes |
| | are ranked as D. Additionally, the number of |
| | the dots each including 3 or more minute dots |
| | within an area of a concentric circle having a |
| | radius 3 times as large as the dot diameter |
| | amounts to 10% or more of the number of the |
| | normal dots. |
| E | The drawing is not carried out in conformity |
| | with the pattern. The number of the defective |
| | dots is 5% or more of the number of the normal |
| | dots. |

TABLE 7
Results of drawing quality evaluation

| | A | B | C | D | E | F |
|---|---|---|---|---|---|---|
| Color 1 | B | A | A | A | A | A |
| Color 2 | A | A | A | A | A | A |
| Color 3 | A | A | A | A | A | A |
| Color 4 | A | A | A | A | A | A |
| Color 5 | A | A | A | A | A | A |
| Color 6 | A | A | A | A | A | A |
| Average in | B | A | A | A | A | A |
| nozzle columns | | | | | | |

The results shown in Table 7 are lined up in the order of accuracy to obtain the evaluation result of B=C=D=E=F>A.

From the evaluation results of (1-1), it is revealed that the accuracy of the nozzle columns E and F is satisfactory, and the accuracy of the nozzle columns A, B, C and D is over the threshold value. In the evaluation results of (1-2) to (1-4), a comparison between E and F reveals that the accuracy of E is better than the accuracy of F.

On the basis of the above results, a probe array was produced by use of the nozzle column E, and consequently a DNA chip having an accuracy better than the threshold value could be produced as a good product. Additionally, a probe array was produced by use of the nozzle column F, and consequently a DNA chip having an accuracy better than the threshold value could be produced as a good product. Furthermore, the evaluations such as (1-1) to (1-4) were carried out, and when the drawing accuracy of any one of the nozzle columns came to be worse than the threshold value, the head was replaced.

Consequently, it has become possible to exclusively produce probe arrays as good products (articles), and thus the yield has been improved, and at the same time, it has become possible to know accurately the appropriate timing for replacing the head.

Additionally, a microscope is attached to the drawing device holding the carrier, and by use of the image processing software (Image-Pro Plus manufactured by Planetron, Inc.), the operations from the drawn image acquisition to the accuracy examination are automated for all the evaluations of the arrival accuracy evaluation, the arrival area evaluation, the arrival shape evaluation and the drawing quality evaluation; in this way, it has become possible to reduce the time concerning the drawing evaluation and at the same time it has become possible to produce better probe arrays as good products, the yield is improved, and it has become possible to know accurately the appropriate timing for replacing the head.

### Example 2

Case of Multi-Nozzle Head

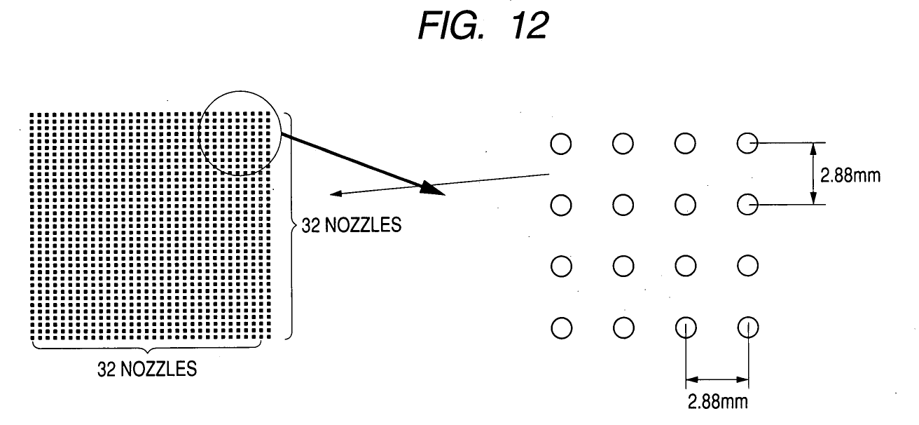

A multi-nozzle head means an inkjet head capable of drawing at a time 1,024 different solutions at the maximum. The arrangement of the nozzles is as shown in FIG. 12, the intervals between the nozzles are 2.88 mm either along the up and down direction or along the side to side direction. Now, description will be made below of the drawing steps in FIG. 2 using the multi-nozzle head.

Additionally, in the present example, a solution composed of 76.5 mass % of purified water, 7.5 mass % of glycerin, 7.5 mass % of urea, 7.5 mass % of thiodiglycol, and 1.0 mass % of acetylenol (E100) was used.

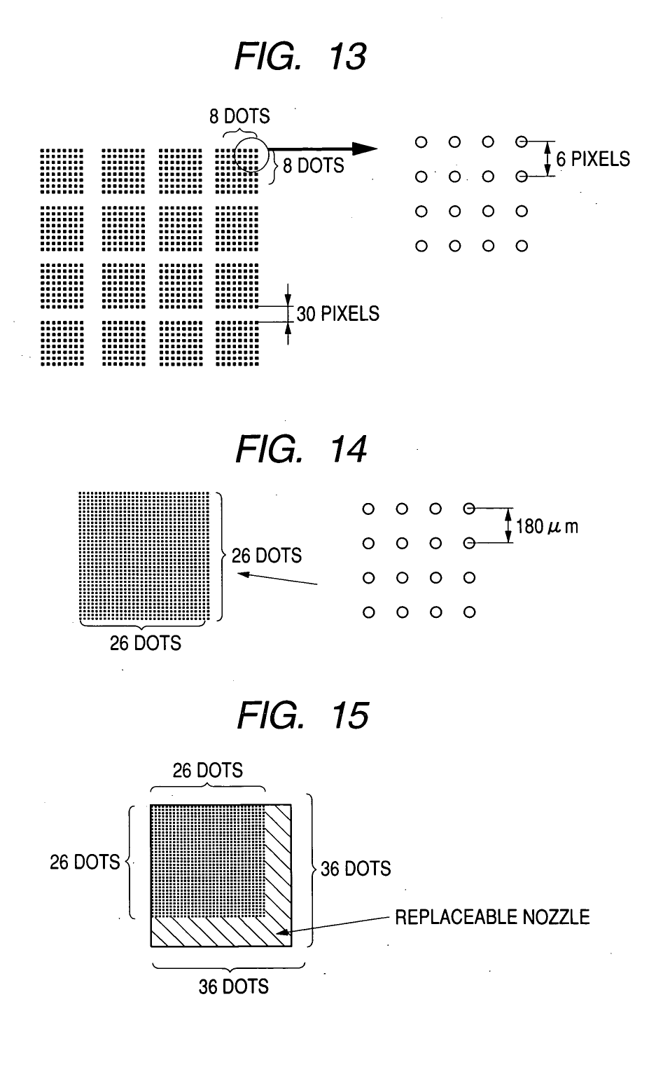

First of all, the test pattern for checking a discharge failure in the drawing steps of FIG. 2 was formed as shown in FIG. 13.

In FIG. 13, 1,024 nozzles are partitioned into arrays of 8×8 dots, the intervals between dots are 6 pixels, the distances between the arrays are 30 pixels, and the patterns are drawn in a manner of one dot by one nozzle. The visual checking of checking a discharge failure after the drawing is made to be easy.

On the basis of the test pattern for checking the discharge failure, the checking of the discharge failure can be carried out for all the nozzles of the head, and hence it becomes possible to discriminate beforehand the usable nozzles from the non-usable nozzles. The DNA chips to be produced use the head in some cases under the conditions such that the number of all the nozzles of the head is different from the number of the different solutions, and accordingly, even when several nozzles fail in discharge, the discharge failure nozzles can be replaced by other usable nozzles free from discharge failure. In the following, description will be made below of the case where the head is used under the conditions such that the number of all the nozzles of the head is different from the number of the different solutions.

As a result of drawing a test pattern for checking discharge failure on a synthetic quartz glass substrate, the number of the discharge failure nozzles was 4. The 4 nozzles were subjected to repeated checking of discharge failure with the aid of the duplicate recovery, but no improvement was attained, so that these nozzles were judged to be non-usable.

Additionally, a microscope was attached to the drawing device holding the carrier, and by use of the image processing software (Image-Pro Plus manufactured by Planetron, Inc.) the operations from the drawn image acquisition to the checking of discharge failure were automated, so that it has become possible to reduce the time concerning the checking of the discharge failure of all the nozzles.

In the next place, the pre-drawing was carried out for the nozzles free from discharge failure, and in the present case, the number of the colors used in the final drawing was 676. Because the matrix as shown in FIG. 14 was intended to be drawn in the final drawing, the used test pattern for the pre-drawing was made to be the same as the pattern of FIG. 14. FIG. 14 shows a matrix of 26 dots×26 dots and the intervals between the dots are 180 μm. The drawing was made to be carried out in a manner of one dot by one nozzle; in the present case, there were found 4 discharge failure nozzles, so that the drawing for the positions expected to be drawn by the discharge failure nozzles was carried out by other replacement nozzles. In FIG. 15, the shaded area is the portion that was able to be used by the replacement nozzles, and the shaded area corresponds to 344 nozzles. The test pattern for pre-drawing shown in FIG. 14 was drawn on a synthetic quartz glass substrate as a set of 16 matrixes, and then the drawn image of each of the matrixes was acquired with the aid of a microscope.

Each of the drawn images was analyzed with the aid of the image processing software, and thus, the numerical values for the center of gravity XY coordinates, the dot area and the radius ratio of each of the dots were obtained.

Additionally, the substrate to be used for drawing evaluation need not be a synthetic quartz glass substrate, but can be a substrate made of an unexpensive material similar to the carrier.

Now, description will be made below of the details of the respective evaluation items and the obtained results.

(2-1) Arrival Position

The centers of gravity XY coordinates (X, Y) of the respective matrixes obtained by the aid of the image processing software were subjected to the 0 correction by use of the least squares method, and the coordinate transformation similar to that in (1-1) of Example 1 was carried out. The coordinates of the respective dots subjected to the coordinate transformation are represented by (X_{N}, Y_{N}) After the coordinate transformation, similarly to (1-1) of Example 1, the centers of gravity positions (X_{g}, Y_{g}) of the respective matrixes are obtained, and from these coordinates, the ideal lattice coordinates are formed. In the case of the present case, the ideal lattice coordinates (Xᵣ, Yᵣ) are represented by the following Equations 3 and 4:

Xᵣ=X_{g}+180×r{r=±(N+½) (N=0 to 12)} Equation 3

Yᵣ=Y_{g}+180×r{r=±(N+½) (N=0 to 12)}

### Equation 4

From the differences between the ideal lattice coordinates (X_{T}, Y_{T}) and the real coordinates (X_{N}, Y_{N}) subjected to the coordinate transformation, the deviation magnitudes of the arrival positions at the time of drawing from the ideal lattice coordinates can be obtained. In the present case, the deviation magnitudes of 676 dots can be found from a matrix. There are 16 matrixes in total, and hence, in principle, the data for 16 dots can be obtained for one nozzle. The 3σ values obtained from the deviation magnitudes of the 16 dots for the X direction and the Y direction were used for evaluation as the X direction variation and the Y direction variation, respectively. The threshold value is ±20 μm. A nozzle for which the associated deviation magnitudes fell within the threshold value was judged to be a good nozzle, and in the case of a nozzle for which the associated deviation magnitude of the X or Y direction, or the associated deviation magnitudes of both directions were worse than the threshold value in accuracy, the nozzle was judged to be a defective nozzle. (See Table 8: Results of arrival position evaluation with a multi-nozzle head.)

TABLE 8
Results of arrival position evaluation with
multi-nozzle head

| | | Number of |
|---|---|---|
| | | dots |
| Good nozzle (within threshold) | | 673 |
| Defective nozzle | Disturbed randomly | 2 |
| (outside threshold) | Shifted along one direction | 1 |

As can be seen from the evaluation results shown in Table 8, the number of good nozzles was 673. There were 3 defective nozzles, and 2 nozzles of the 3 nozzles exhibited arrival positions shifted along random directions, while the other nozzle exhibited an arrival position shifted along a certain direction. Consequently, the 2 nozzles exhibiting shifts along random directions were replaced by other nozzles, and for the other nozzle exhibiting shifts along a certain direction, the drawing pattern was subjected to correction; then the pre-drawing was carried out once again for the arrival position evaluation, and all the 676 nozzles were found to fall within the threshold value.

(2-2) Arrival Area

The arrival areas (dot areas) obtained from the respective matrixes with the aid of the image processing software were evaluated as follows. There are 16 matrixes, and hence each nozzle has 16 area values. When the average value of these 16 area values was outside the threshold value, the nozzle concerned was judged to be a defective nozzle. The results of the arrival area evaluation are shown below in terms of the items. The threshold value is such that 1,400 μm²<the average area of each nozzle [μm²]<2,000 μm² (see Table 9: Results of arrival area evaluation for the multi-nozzle head).

TABLE 9
Results of arrival area evaluation for
multi-nozzle head

| | Number of dots |
|---|---|
| Good nozzle (within threshold) | 674 |
| Defective nozzle (outside threshold) | 2 |

As can be seen from the results shown in Table 9, 674 nozzles of a total number of 676 nozzles fell within the threshold value, and consequently these 674 nozzles were good nozzles.

Additionally, 2 dots fell outside the threshold value (800 μm², 920 μm²), and accordingly were defective nozzles. The 2 nozzles evaluated to be defective nozzles were both smaller in area than the threshold value, and hence the discharge amounts were adjusted; then, the pre-drawing was carried out once again for the arrival area evaluation, and all the 676 nozzles were found to fall within the threshold value. In this case, the repeated pre-drawing was carried out in concurrence with the (2-1).

(2-3) Arrival Shape

By use of the radius ratios obtained from the respective matrixes with the aid of the image processing software, the arrival shapes were evaluated as follows.

For every nozzle, when dot had the radius ratio of 1.4 or more, it was judged as an abnormal shape, and the number of such abnormal dots was counted. The threshold value was set at 0.2 per one dot. The results of the evaluation of the nozzles are shown below in terms of the items (see Table 10. Results of radius ratio evaluation).

TABLE 10
Results of radius ratio evaluation

| | Number of dots |
|---|---|
| Good nozzle (within threshold) | 675 |
| Defective nozzle (outside threshold) | 1 |

As can be seen from the results shown in Table 10, 675 nozzles of a total number of 676 nozzles fell within the threshold value, and consequently these 675 nozzles were good nozzles.

Additionally, one nozzle fell outside the threshold value (0.23) and was a defective nozzle. The nozzle evaluated as a defective nozzle was replaced by another nozzle, and the pre-drawing was carried out once again for the radius ratio evaluation, and consequently all the 676 nozzles were found to fall within the threshold value. In this case, the repeated pre-drawing was carried out in concurrence with the above (2-1) and (2-2).

(2-4) Drawing Quality

The drawing quality was evaluated in a sense similar to that in (1-4) of Example 1, but the definition of the ranking is somewhat different from that in (1-4) of Example 1, so that the threshold values for ranking are shown in Table 11. In the present case, the drawing quality was evaluated for every nozzle, and when the rank of a nozzle was found to be one of C, D and E, the nozzle was used as little as possible, and was replaced by another nozzle (see Table 11: Threshold values for ranking of drawing quality). The evaluation results are shown in Table 12 (Table 12: Results of drawing quality evaluation).

TABLE 11
Threshold values for ranking of drawing quality

| Rank | Threshold values for ranking |
|---|---|
| A | The conditions of the ranks D and E are not |
| | satisfied, and the number of the dots each |
| | including minute dots within an area of a |
| | concentric circle having a diameter 3 times as |
| | large as the dot diameter is less than 5% of |
| | the number of the normal dots. |
| B | The conditions of the ranks D and E are not |
| | satisfied, and the number of the dots each |
| | including minute dots within an area of a |
| | concentric circle having a diameter 3 times as |
| | large as the dot diameter is 5% or more and |
| | less than 20% of the number of the normal dots. |
| C | The conditions of the ranks D and E are not |
| | satisfied, and the number of the dots each |
| | including minute dots within an area, of a |
| | concentric circle having a diameter 3 times as |
| | large as the dot diameter is 20% or more of the |
| | number of the normal dots. |
| D | The condition of the rank E is not satisfied, |
| | the number of the dots each including 3 or more |
| | minute dots within an area of a concentric |
| | circle having a diameter 3 times as large as |
| | the dot diameter amounts to 10% or more of the |
| | number of the normal dots. |
| E | The drawing is not carried out in conformity |
| | with the pattern. The number of the defective |
| | dots is 5% or more of the number of the normal |
| | dots. |

TABLE 12
Results of drawing quality evaluation

| Rank | Number of dots |
|---|---|
| A | 672 |
| B | 3 |
| C | 1 |
| D | 0 |
| E | 0 |

As can be seen from the results shown in Table 12, 672 nozzles of 676 nozzles were ranked as A, 3 nozzles were ranked as B, and 1 nozzle was ranked as C. The nozzle of rank C was desired to be used as little as possible, and hence the nozzle was subjected to another recovery and then the pre-drawing was carried out once again; consequently, the nozzle concerned came to be ranked as B. In this case, the repeated pre-drawing was carried out in concurrence with the above (2-1) to (2-3).

As can be seen from the results described above, the results obtained in the above (2-1) to (2-4) were made to be fed back for selection of optimal nozzles, then the final drawing was carried out, and thus a probe array better in accuracy than the threshold value could be produced. Furthermore, the evaluations such as the above (2-1) to (2-4) were carried out, and when the evaluation results are worse than the threshold value and hence a nozzle was desired to be substituted, but no replacement nozzles was available, the liquid discharging head was replaced.

On the basis of these results, exclusively good products (articles) can be produced; more specifically, there can be produced probe arrays in which in the formed image, the variation of the arrival areas is ±25% or less, the average deviation magnitude from the ideal lattice positions is ±15% or less. Such probe arrays permit more accurate relative comparison between the respective dots, and accordingly permit quantitative analysis. The small average deviation magnitude from the ideal lattice positions makes it possible to carry out relatively easily the image analysis including fluorescence observation.

Additionally, according to the above-mentiond production method, the process yield is improved, and it has become possible to accurately know the timing of replacement of the liquid discharging head.

Additionally, it has been confirmed that by supplying the probe solutions to the liquid discharging head after the drawing accuracy evaluation has been beforehand carried out for all the nozzles, and after the nozzles satisfactory in accuracy have been selected, the operations from the checking of discharge failure to the pre-drawing are made to proceed smoothly; and when replacement nozzles are allotted and the repeated evaluation is conducted in the pre-drawing evaluation, the replacement nozzles can be selected efficiently, and thus the final drawing can be made.

Additionally, a microscope is attached to the drawing device holding the carrier, and by use of the image processing software (Image-Pro Plus manufactured by Planetron, Inc.), the operations from the drawn image acquisition to the accuracy examination are automated for all the evaluations of the arrival accuracy evaluation, the arrival area evaluation, the arrival shape evaluation and the drawing quality evaluation; in this way, it has become possible to reduce the time required for the drawing evaluation and at the same time it has become possible to produce good probe arrays, the yield is improved, and it has become possible to know accurately the appropriate timing for replacing the head.

The present invention is not limited to the above embodiments and various changes and modifications can be made within the spirit and scope of the present invention. Therefore to apprise the public of the scope of the present invention, the following claims are made.

What is claimed is:

1. A production method of a probe carrier having an image which is formed by arranging a plurality of immobilized areas of a probe independent from one another at predetermined positions on the carrier, comprising:
a first drawing step of supporting the carrier by a supporting device, relatively moving a liquid discharging head having a plurality of liquid discharging units in relation to the carrier, discharging a probe solution containing the probe capable of being specifically bonded to a target substance to predetermined positions on the carrier from predetermined liquid discharging units, and drawing a preliminary image comprising a plurality of immobilized areas of the probe independent from one anther on the carrier;
an evaluating step of evaluating a drawing accuracy of the preliminary image on the carrier;
a step of setting drawing conditions to which results of evaluation of the drawing accuracy are fed back; and
a second drawing step of, under the drawing conditions, relatively moving the liquid discharging head having the plurality of liquid discharging units in relation to a carrier supported on a supporting device, discharging the probe solution containing the probe capable of being specifically-bonded to the target substance to predetermined positions on the carrier from the predetermined liquid discharging units, and drawing a final image comprising a plurality of immobilized areas of the probe independent from one another on the carrier to obtain the probe carrier.

2. The production method according to claim 1, wherein the drawing conditions in the second drawing step are drawing conditions under which the drawing accuracy in the second drawing step is higher than the drawing accuracy in the first drawing step.

3. The production method according to claim 1, wherein the liquid discharging head comprises a thermal energy generator for discharging the probe solution from the liquid discharging units.

4. The production method according to claim 1, wherein the probe is selected from the group consisting of DNA, RNA, cDNA, PNA, oligonucleotides, polynucleotides, other nucleic acids, oligopeptides, polypeptides, proteins, enzymes, substrates for enzymes, antibodies, epitopes for antibodies, antigens, hormones, hormone receptors, ligands, ligand receptors, oligosaccharides, and polysaccharides.

5. The production method according to claim 1, further comprising a discharge failure checking step of preliminarily checking if discharge from each of the liquid discharging units of the liquid discharging head used in the first drawing step is successful or not, and according to the checking results, if necessary, carrying out adjustment of the liquid discharging head.

6. The production method according to claim 5, wherein the discharge failure checking step is carried out by drawing on the carrier a discharging failure-checking pattern for checking discharge failure of all or a predetermined part of the liquid discharging units of the liquid discharging head.

7. The production method according to claim 1, wherein the first drawing step is a step of drawing a test pattern for use in a preliminary drawing for evaluating the drawing accuracy of the liquid discharging head.

8. The production method according to claim 7, wherein the test pattern for use in the preliminary drawing is a pattern for evaluating the drawing accuracy of all the liquid discharging units of the liquid discharging head.

9. The production method according to claim 7, wherein the evaluation of the drawing accuracy is carried out by forming an image of the test pattern for use in the preliminary drawing through an optical system, and evaluating at least one item selected from the group consisting of arrival position, arrival shape, arrival area and drawing quality of arrived droplet on the image.

10. The production method according to claim 9, wherein quality judgment in the evaluation of each of the items is carried out by comparison with a predetermined threshold value.

11. An apparatus for producing a probe carrier having an image which is formed by arranging a plurality of immobilized areas of a probe independent from one another at predetermined positions on a carrier, comprising:
a supporting device for supporting the carrier;
a liquid discharging head comprising a solution holding unit for holding a probe solution containing a probe capable of being specifically bonded to a target substance, and a plurality of liquid discharging units each comprising a discharging opening for discharging a probe solution supplied from the solution holding unit;
a movement means for relatively moving the liquid discharging head in relation to the carrier supported by the supporting device; and
a control means for drawing on the carrier an image comprising a plurality of the immobilized areas of the probe independent from one another by discharging the probe solution from the predetermined liquid discharging units of the liquid discharging head to predetermined positions on the carrier supported by the supporting device,
wherein the control means further comprising a program for use in the first drawing step of drawing on the carrier the test pattern for use in the preliminary drawing for evaluating the drawing accuracy of the liquid discharging head, and a program for use in the second drawing step of forming the probe carrier by driving the liquid discharging head under a drawing condition that the evaluation results based on the test pattern for use in the preliminary drawing are reflected.

12. The apparatus according to claim 11, wherein a drawing condition in the second drawing step is a drawing condition that a drawing accuracy in the second drawing step is higher than a drawing accuracy in the first drawing step.

13. The apparatus according to claim 11, wherein the liquid discharging head comprises a thermal energy generator for discharging the probe solution from the liquid discharging units.

14. The apparatus according to claim 11, wherein the probe is selected from the group consisting of DNA, RNA, cDNA, PNA, oligonucleotides, polynucleotides, other nucleic acids, oligopeptides, polypeptides, proteins, enzymes, substrates for enzymes, antibodies, epitopes for antibodies, antigens, hormones, hormone receptors, ligands, ligand receptors, oligosaccharides, and polysaccharides.

15. The apparatus according to claim 11, wherein the control means further comprises a program for drawing on the carrier supported by the supporting device a discharge failure-checking pattern for checking whether discharge from all or a predetermined part of the liquid discharging units of the liquid discharging head used in the first drawing step.

16. The apparatus according to claim 11, wherein the test pattern for use in the preliminary drawing is a pattern for evaluating a drawing accuracy of all the liquid discharging units of the liquid discharging head.
